(19) United States
(12) Patent Application Publication
(10) Pub. No.: US 2017/0266745 A1
(43) Pub. Date: Sep. 21, 2017

(54) METHOD OF PRODUCING AN IMPULSE MISTUNING COMPONENT

(71) Applicant: MTU Aero Engines AG, Munich (DE)

(72) Inventor: Karl-Hermann RICHTER, Markt Indersdorf (DE)

(21) Appl. No.: 15/459,104

(22) Filed: Mar. 15, 2017

(30) Foreign Application Priority Data
Mar. 16, 2016 (EP) 16160546.4

(51) Int. Cl. B23K 1/18; B23K 1/002; F01D 25/04; B23K 1/008; B23K 1/20; B23K 1/00; B23K 1/005

(52) U.S. Cl. CPC B23K 1/18; B23K 1/0018; B23K 1/002; B23K 1/0056; B23K 1/008; B23K 1/206; F01D 25/04; B23K 2201/001

(57) ABSTRACT

The invention relates to a method for producing a mistuning component. The method comprises the following steps:
a) producing a container (34) having at least one chamber (36);
b) producing a lid (32, 32′);
c) inserting at least one impulse element into the chamber (36);
d) joining the lid (32, 32′) and the container (36), wherein joining is carried out by soldering/brazing.

The invention relates to a method for producing an impulse mistuning component, according to the preamble of claim 1.

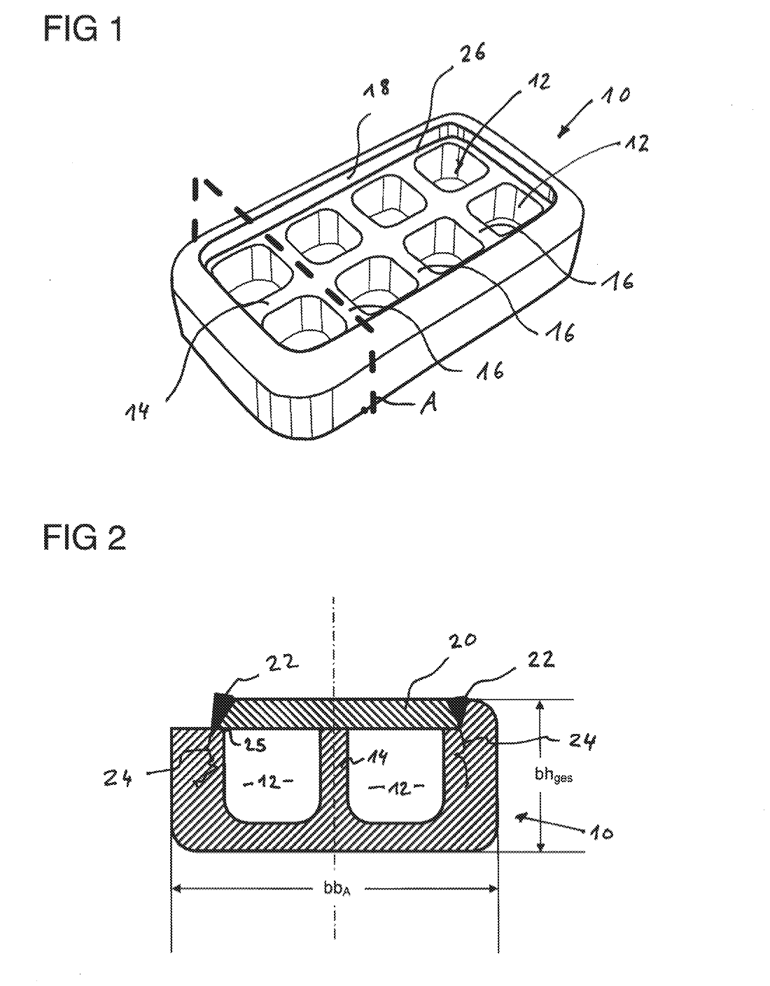

Such an impulse mistuning component is disclosed for example in the application DE 10 2014 223231 (not yet published at the time of filing the present application). The impulse mistuning component here is illustrated in a perspective manner in FIG. 1 without the associated lid. FIG. 2 on the right side shows a section through the plane A. FIG. 2 shows two dissimilar known embodiments. The impulse mistuning component here has a substantially box-shaped container 10. Eight mutually separated chambers 12 are sunk into the container 10, said chambers 12 being delimited by a longitudinal separation wall 14 and by three transverse separation walls 16. The container furthermore has a collar 18 (only depicted on the right in FIG. 2) that runs about the circumference of the container and in terms of height protrudes beyond the longitudinal separation wall 14 and the transverse separation walls. This collar 18 serves as the receptacle for the lid 20 that is shaped in a corresponding matching manner. The lid 20 herein has to have an accuracy of better than 2/100 mm. After the chambers 12 have been filled with a ball the lid 20 is placed in the receptacle that is located between the collar 18. The lid 20 is subsequently welded to the container 10. A wedge-shaped weld seam 22 can be seen in FIG. 2. However, notches or fissures 24, respectively, can arise in the direction of the weld seam. The formation of fissures is compounded by the internal edge 26. The component can even fail completely under operating conditions.

In another embodiment which is depicted on the left side of FIG. 2, the container 10 does not have any receptacle for the lid 20, such that there is also no internal edge 26. Welding of the lid 20 to the container 10 is carried out in that the heat source is offset by 0.1 to 0.2 mm relative to the periphery of the lid in the direction of the center of the lid. On account thereof, the lid acts in part as additional material. However, notches or fissures 24, respectively, in the direction of the weld seam can also arise here. A notch 25 which can result in the lid 20 shearing off is created in the non-welded region between the lid 20 and the container 10.

The present invention is thus based on the object of proposing a method for producing an impulse mistuning component such that hardly any or no fissures arise in the mistuning component under operating conditions.

The object is achieved by the features of claim 1.

The invention relates to a method for producing an impulse mistuning component for a turbine. The method comprises substantially the steps that are listed hereunder. in step a) a container having at least one chamber is produced. in step b) a lid is produced. Subsequently, in step c), an impulse element is inserted into the chamber. In step d) the lid and the container are then joined, wherein joining is carried out by soldering/brazing.

The impulse element herein can be a simple ball. Cylindrical elements are also conceivable. The shape depends on the shape of the chamber or pocket, respectively, in which the impulse element is later placed. It is only important for the chamber to be larger than the impulse element such that the latter has sufficient space for moving back and forth in the chamber.

It is advantageous herein that notches do not arise in the joining zone. The service life of the mistuning component is thus significantly increased. It is to be noted the container can have more than one mutually separated chambers. These chambers can then be disposed in the form of an egg box.

In one advantageous design embodiment of the invention, a furnace, an inductive coil, a laser beam, and/or an electron beam are/is used as a heat source for soldering/brazing. The heat treatment can furthermore be carried out in a vacuum and/or in a protective atmosphere. The vacuum can have a residual pressure of 10⁻⁵ mbar to 10⁻³ mbar.

In one further advantageous design embodiment of the invention, the sequence of steps a) and b) is arbitrary. Step c) herein follows step a), and step d) herein follows steps b) and c).

In one further advantageous design embodiment of the invention, the production of the lid in step b) is carried out by punching, by laser beam welding, and/or by spark erosion. In the production by means of spark erosion (EDM=electrical discharge machining), an oxide layer in the form of a recast layer is created on the surface of the lid. Such an oxide layer has the advantage that it acts in a wetting-inhibiting manner. It can thus be prevented in a targeted manner that solder reaches undesirable locations. Those locations to which the solder is to be applied have to be relieved of the oxide layer. In general, lids can be produced in an extremely cost-effective manner by punching.

In one further advantageous design embodiment of the invention, the production of the container in step a) is carried out by spark erosion, electrochemical processing, and/or mechanical subtraction, in particular by milling and/or grinding. In the production by means of spark erosion (EDM=electrical discharge machining), an oxide layer in the form of a recast layer is created on all surfaces of the container, and thus also on the walls that enclose the chamber. It is thus advantageously prevented that solder ingresses into the chamber and disturbs or impedes, respectively, the mobility of the impulse element. Those locations to which the solder is to be applied have to be relieved of the oxide layer. A nickel alloy such as, for example, Haynes 230 is preferably used for the container.

In one further advantageous design embodiment of the invention, after step a) and before step c) the internal wall of the chamber is irradiated with Al₂O₃. In particular, when the container has been produced by means of mechanical subtraction or electrochemical processing (ECM=electrochemical machining). The periphery of the container herein can either be covered, or the surface of the irradiated periphery is subtracted.

In one further advantageous design embodiment of the invention, before step d) at least one encircling part of the container to which the solder is applied before step d) is relieved of oxide. This has the advantage that a high-grade soldered/brazed connection can be created.

In one further advantageous design embodiment of the invention, the soldering/brazing time in step d) is 1 s to 60 s.

In one further advantageous design embodiment of the invention, a preshaped filler is placed on the container and/or on the lid before step d), The preshaped filler can be cut out, for example by laser beam cutting, so as to correspond to the contour of the container. A nickel-based solder such as AMS4777 is suitable as a solder material. The thickness of the preshaped filler can be 25 μm to 50 μm.

In one further advantageous design embodiment of the invention, the preshaped filler is adhesively bonded to both sides on the lid and on the container before step d). As a result, the two parts are fixed to one another. A respective adhesive can evaporate without residue in step d). This has the advantage that handling is significantly simplified. Alternatively, the completed component (container, lid, and preshaped filler) can be fixed by means of tack welding. One tacking point per side can be provided herein.

In one further advantageous design embodiment of the invention, the external width bb_{A} of the container and the external width fb_{A} of the preshaped filler meet the condition bb_{A}≧fb_{A}. Furthermore, the internal width bb_{I} of the container and the internal width fb_{I} of the preshaped filler meet the condition bb_{I}≦fb_{I}, where fb_{A}>fb_{I}. Furthermore, the external length bL_{A} of the container and the external length fL_{A} of the preshaped filler can meet the condition bL_{A}≧fL_{A}, and the internal length bL_{I} of the container and the internal length fL_{I} of the preshaped filler can meet the condition bL_{I}≦fL_{I}, where fL_{A}>fL_{I}. In one particular embodiment, the preshaped filler goes up to the periphery of the container. Here: bb_{A}=fb_{A} and bL_{A}=fL_{A}. This has the advantage that encircling soldering/brazing can be performed, such that the chamber is dosed off from the external environment in a gas-tight manner. In order for the lid to terminate so as to be flush with the container, the dimensions of the lid have only to meet the following conditions: db_{A}≧bb_{A} and dL_{A}≧bL_{A}, where db_{A} is the lid width, and dL_{A} is the lid length. Should the lid have the same external dimensions as the container, the lid in step d) is to be aligned so as to be flush with the container. However, the lid can be somewhat repositioned during soldering/brazing. This can be avoided by suitable fixing.

Alternatively thereto, the lid can be larger than the container in all directions. To this end, after step d) that part of the lid that protrudes beyond the periphery of the container should be mechanically subtracted until the lid is flush with the periphery.

Further advantageous design embodiments of the invention are reflected in the dependent claims.

Preferred exemplary embodiments of the invention will furthermore be described in more detail by means of the schematic drawing in which:

FIG. 1 shows a perspective view of a known mistuning component;

FIG. 2 shows a cross section along the plane A of FIG. 1;

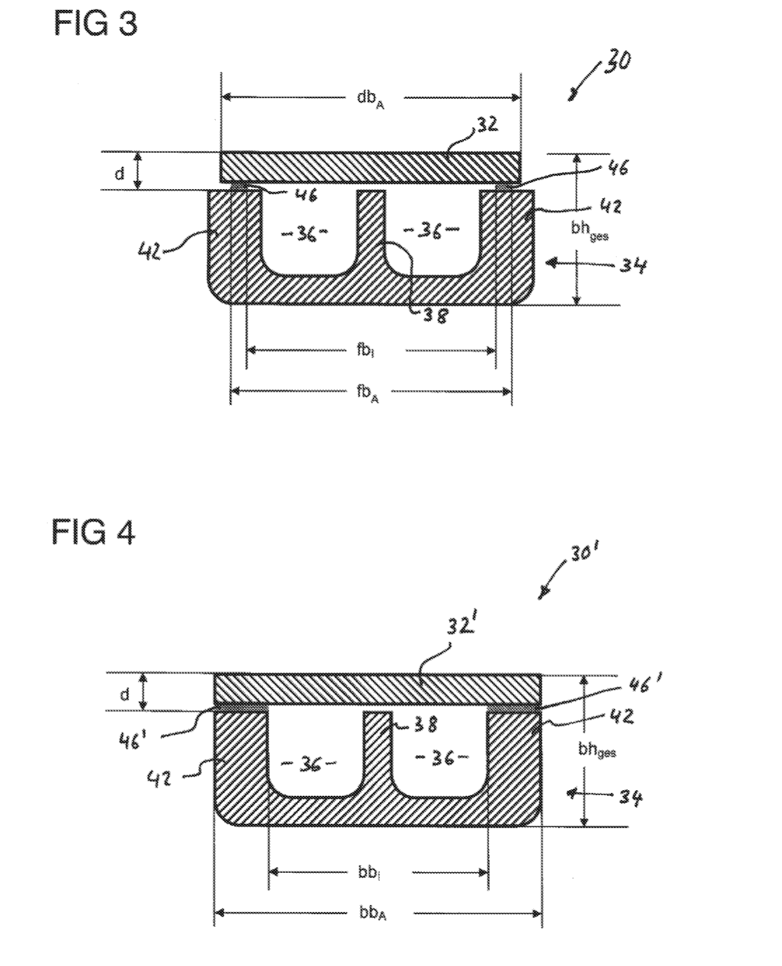

FIG. 3 shows a cross section through a first embodiment of a mistuning component produced according to the invention;

FIG. 4 shows a cross section through a second embodiment of a mistuning component produced according to the invention;

FIG. 5 shows a plan view of the container of the mistuning component of FIGS. 3 and 4; and

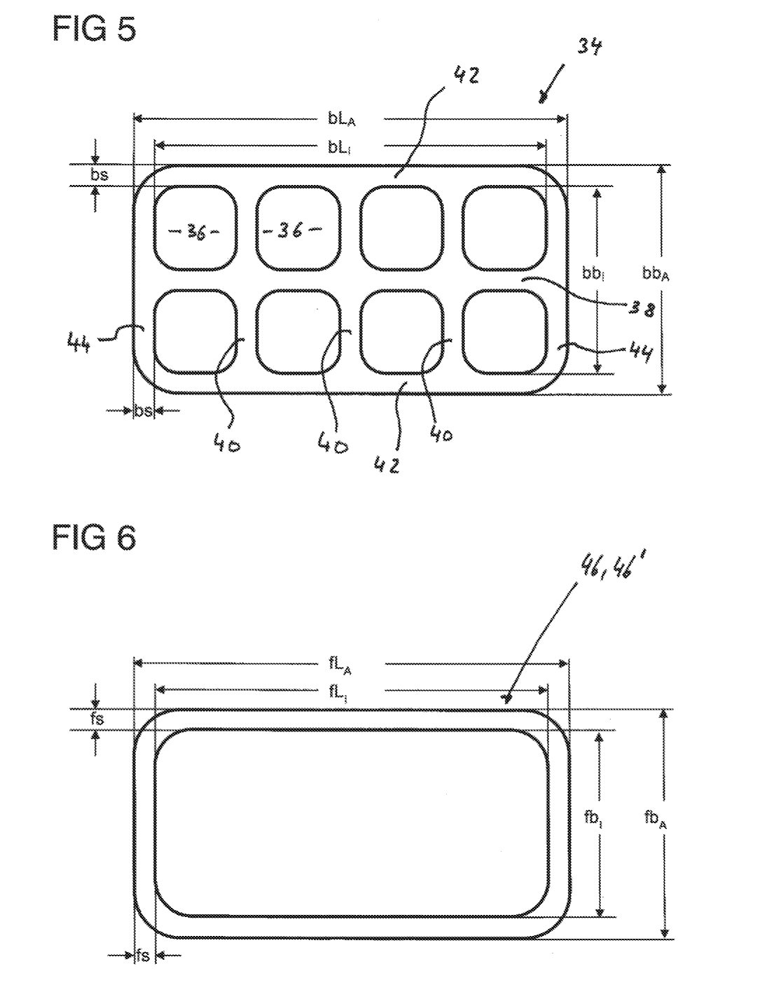

FIG. 6 shows a plan view of a preshaped filler used in the production.

A cross section through a mistuning component 30, 30′ having a lid 32, 32′ and a box-shaped container 34 is depicted in FIGS. 3 and 4. The container 34 used in the two FIGS. 3 and 4 can be seen in a plan view in FIG. 5. The box-shaped container 34 having a rectangular footprint herein has eight chambers 36 of identical size. These chambers 36 on the inside are mutually separated by a longitudinally running separation wall 38 and by three transversely running separation walls 40. These presently identical chambers 36 on the outside are bordered by two longitudinal external walls 42, running in a substantially mutually parallel manner, having an external length bL_{A}, and by two transverse external walls 44, running in a substantially mutually parallel manner, having an external width bb_{A}. The separation walls 38 and 40 presently have an identical height to the external walls 42 and 44 (see height h in FIG. 3) such that there is no collar, as can be derived from FIGS. 3 and 4. The widths bs of the external walls 42 and 44 are preferably of identical size. The internal length bL₁ which presently reaches from the chamber on the extreme left to the chamber on the extreme right is an important dimension. The internal width bb_{I} which reaches from the upper chamber to the lower chamber is a further important dimension. These dimensions are important for both the dimensions of the preshaped filler that is depicted in FIG. 6 as well as for the dimensions of the lid 34.

A plan view of the preshaped filler 46 to be used is in FIG. 6. The preshaped filler 46 presently is a substantially rectangular frame having an external length fL_{A}, an internal length fL_{I}, an external width fb_{A} and an internal width fb_{I}.

In the first embodiment (see FIG. 3), the width db_{A} of the lid as well as the length dL_{A} (not depicted) of the lid are smaller than the dimensions of the container, that is to say that bb_{A}>db_{A} and bL_{A}>dL_{A}. Nevertheless, part of the lid 32 bears on the external walls 42 and 44, so as to enable gas-tight joining. The frame-shaped preshaped filler 46 is dimensioned in such a manner that it presently bears in a substantially quite centric manner on the surface of the external walls 42 and 44. Herein in FIG. 3 fb_{I}>bb_{I} and fb_{A}<bb_{A} and fL_{I}>bL_{I} and fL_{A}<bL_{A}. This has the advantage that the solder is somewhat spaced apart from the chambers 36 such that the risk of solder being able to flow into the chambers is low.

A second embodiment of a mistuning component 30′ produced according to the invention is in FIG. 4. By contrast to the first embodiment, the lid 32′ now has the same dimensions as the container 34, that is to say: bb_{A}=db_{A} and bL_{A}=dL_{A}. As has already been explained above, these conditions do not have to be met before step d). The frame-shaped preshaped filler 46′ is dimensioned such that it runs in a substantially flush manner in relation to the chambers 36 on the inside, and runs in a substantially flush manner in relation to the external walls 42 and 44 on the outside. Herein in FIG. 4 fb_{I}=bb_{I} and fb_{A}=bb_{A} and fL_{I}=bL_{I} and fL_{A}=bL_{A}.

The method according to the invention will now be described hereunder. In steps a) and b) the lids 32′ are punched preferably from metal, and the egg-box-shaped container 34 is produced. At least one ball (impulse element) is inserted into each chamber 36. Subsequently, the sticky lower side of the preshaped filler 46′ is adhesively bonded to the external walls 42 and 44 of the container 34. The lid 32′ is adhesively bonded to the sticky upper side of the preshaped filler 46′. Attention has to be paid herein that all three parts (preshaped filler, lid, container) are mutually aligned so as to be flush. The preshaped filler 46′ is subsequently made to melt.

### LIST OF REFERENCE SIGNS

10 Container
12 Chamber
14 Longitudinal separation wall
16 Transverse separation wall
18 Collar
20 Lid
22 Weld seam
24 Fissure
25 Notch
26 Internal edge
30 Mistuning component
32 Lid
34 Container
36 Chamber
38 Longitudinally running separation wall
40 Transversely running separation wall
42 Longitudinal external wall
44 Transverse external wall
46 Preshaped filler
A Plane
bb_{A} External width of the container
bb_{I} Internal width of the container
bL_{A} External length of the container
bL_{I} Internal length of the container
bs Wall thickness of the external walls
db_{A} Width of the lid
dL_{I} Length of the lid
fb_{A} External width of the preshaped filler
fb_{I} Internal width of the preshaped filler
fL_{A} External length of 46
fL_{I} External length of 46
fs Wall thickness of 46
h Height of the container
h_{gas} Overall height of the mistiming component

1.-13. (canceled)

14. A method for producing an impulse mistuning component for a turbine, wherein the method comprises (a) inserting at least one impulse element into a chamber of a container which comprises at least one chamber, and (b) joining a lid and the container by soldering/brazing.

15. The method of claim 14, wherein a furnace, an inductive coil, a laser beam, and/or an electron beam are/is used as a heat source for soldering/brazing.

16. The method of claim 15, wherein a heat treatment is carried out in a vacuum and/or in a protective atmosphere.

17. The method of claim 14, wherein the lid is produced by punching, by laser beam welding, and/or by spark erosion.

18. The method of claim 14, wherein the container is produced by spark erosion, electrochemical processing, and/or mechanical subtraction.

19. The method of claim 14, wherein the container is produced by milling and/or grinding.

20. The method of claim 14, wherein before inserting the at least one impulse element into the chamber, an internal wall of the chamber is treated with a jet of Al₂O₃.

21. The method of claim 14, wherein before joining the lid and the container at least one encircling part of the container to which solder is applied before joining lid and container is freed of oxide.

22. The method of claim 14, wherein soldering/brazing is carried out for 1 s to 60 s.

23. The method of claim 14, wherein before joining lid and container a preshaped filler is placed on the container and/or on the lid.

24. The method of claim 23, wherein the preshaped filler is adhesively bonded to both sides on the lid and on the container before lid and container are joined.

25. The method of claim 23, wherein an external width (bb_{A}) of the container and an external width (fb_{A}) of the preshaped filler meet the condition bb_{A}≧fb_{A}, and an internal width (bb_{I}) of the container and an internal width (fb_{I}) of the preshaped filler meet the condition bb_{I}≦fb_{I}, where fb_{A}>fb_{I}.

26. The method of claim 23, wherein an external length (bL_{A}) of the container and an external length (fL_{A}) of the preshaped filler meet the condition bL_{A}≧fL_{A}, and an internal length (bL_{I}) of the container and an internal length (fL_{I}) of the preshaped filler meet the condition bL_{I}≦fL_{I}, where fL_{A}>fL_{I}.

27. The method of claim 25, wherein an external length (bL_{A}) of the container and an external length (fL_{A}) of the preshaped filler meet the condition bL_{A}≧fL_{A}, and an internal length (bL_{I}) of the container and an internal length (fL_{I}) of the preshaped filler meet the condition bL_{I}≦fL_{I}, where fL_{A}>fL_{I}.
